(19) United States
(12) Patent Application Publication
(10) Pub. No.: US 2005/0050979 A1
(43) Pub. Date: Mar. 10, 2005

(54) Steering column module with single displacement sensor

(75) Inventor: Florian Barcat, Tours (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Nacam France SAS, a corporation of France, Vendome (FR)

(21) Appl. No.: 10/923,912

(22) Filed: Aug. 23, 2004

(30) Foreign Application Priority Data
Sep. 9, 2003 (FR) 03/10602

(51) Int. Cl. B62D 1/16

(52) U.S. Cl. 74/495

(57) ABSTRACT

This invention pertains to a steering column module for commanding motorized positioning comprising a single motor for adjusting the position of the steering wheel along a transverse pivoting axis for the adjustment of the tilt of the steering wheel and along a longitudinal axis for adjusting the depth, the motor driving the displacement of a first threaded joint element providing a first adjustment mechanism along one of the axes and a second threaded joint element driving a second adjustment mechanism along at least the other axis, wherein the motor drives a single incremental position sensor sending a position signal to a controller and the controller comprises an input receiving moreover at least one activation information unit representative of the engagement state of at least one of the joint elements.

### RELATED APPLICATION

This application claims priority of French Patent Application No. 03/10602, filed Sep. 9, 2003.

### FIELD OF THE INVENTION

This invention pertains to steering columns for motor vehicles, more particularly to modules comprising a steering column and motorized means for controlling the tilt and distance of the steering wheel.

### BACKGROUND

It is known to reduce the weight and cost of such modules by using a single motor for providing both axial adjustment and longitudinal adjustment. One or more engaging and disengaging mechanisms provide the transmission between one or more output shafts of the single motor to activate or deactivate driving the mobile parts providing for orientation of the steering wheel.

DE 10144476 A1 discloses to a motor vehicle steering column unit comprising a steering column of adjustable length and/or tilt via electromechanical means. It provides a unit that can be easily adapted to different types of vehicles, can be reconfigured in a variable manner in relation to its functionality from the manufacturing process and which is clearly delimited from the other structural units of the motor vehicle. For this purpose, the motor vehicle steering column unit comprises, in addition to the mechanical elements and adjustment parts required for directional control and the electric modification of the position of the steering column, at least one drive system, an electronic control unit that produces control signals directed to the drive system(s) and electric adjustment parts, as well as connectors intended to link the unit to the vehicle's onboard network.

DE 19641152 describes a unit for a motor vehicle steering column comprising a steering column box and an electrically actuated adjustment device that implements the longitudinal and tilt adjustment of the steering column. The adjustment device has an electrically driven unit that rotates an adjustment spindle and displaces longitudinally and tilting, respectively, at least one adjustment mechanism. For each displacement direction, a switch device provides for engagement or disengagement of a spindle nut positioned near this device.

EP 0461025 describes a motorized position adjustment control device for a steering column that can be adjusted in length and tilt in which the steering column comprises a shaft made of an end section intended to carry a steering wheel and an extendible/retractable intercalary section constituted of two parts assembled by a sliding joint, linking universal joints connecting these sections. That device comprises a fixed part linked to the vehicle and a mobile part constituted of an element sliding relative to the fixed part and an element tilting relative to the sliding element by means of an axial articulation (Y) orthogonal to the axis (X) of the column, as well as bearings supporting the shaft in the mobile part. A transmission associated with a single motor has an input linked to the motor and two outputs in a manner such that one of the outputs creates movement in translation and the other output creates tilting. The two outputs are activated at relatively similar speeds to provide for adjustment in length of the two elements of the mobile part and the shaft sections that they carry. Only one of the outputs is activated to provide for adjustment of the tilt of the tilting element and the shaft section that it carries. The fixed part and the mobile part constitute a sheath, the mobile part sliding in the fixed part in the axial direction.

The prior art proposes solutions to the problem of motorization by means of a single motor of the adjustments of the steering column. For such a module to be fully utilizable, it is desirable to be able to store in memory an axial and longitudinal position suitable for a driver of the vehicle, and to be able to restore this position when this driver so desires.

For this purpose, WO 03/022657 discloses a steering column unit comprising, in addition to the mechanical elements and adjustment means required for direction control and electric modification of the position of the steering control, at least one drive system, an electronic control unit for producing control signals directed to the drive system(s) and the electric adjustment means, as well as connectors for linking the unit to the onboard network. This solution requires expensive control electronics and employs position sensors that need to be integrated in the respective mechanisms for longitudinal and axial adjustment.

DE 3311229 describes an adjustment device using a brushless type step motor controlled by pulse trains. Such a solution is not satisfactory because, in the case of mechanical loss of adjustment of the drive mechanism due, e.g., to wear or overshooting of the course end, the positioning control is erroneous.

It would therefore be advantageous to provide a simplified solution for acquisition of the adjustments and control of the storage in memory and the restoration of an adjustment selected by a driver.

### SUMMARY OF THE INVENTION

This invention relates to a steering column module for commanding motorized positioning including a motor that adjusts the position of a steering wheel associated with the steering column relative to a driver along a transverse pivoting axis for adjustment of the tilt of the steering wheel with respect to the driver and along a longitudinal axis for adjustment of the distance of the steering wheel relative to the driver; a first threaded joint element driven by the motor and providing a first adjustment mechanism along one of the axes; a second threaded joint element driven by the motor and driving a second adjustment mechanism along at least another of the axes; a controller that receives information representative on the state of at least one of the joint elements; and an incremental position sensor driven by the motor that sends a position signal to the controller.

### BRIEF DESCRIPTION OF THE DRAWINGS

Better understanding of the invention will be obtained from the description below with reference to the attached drawings corresponding to nonlimitative examples of implementation, in which:

FIG. 1 is a schematic view of an example of a module comprising independent axial and radial adjustments with one motor and two clutches,

FIG. 2 is a schematic view of the module controller,

FIG. 3 is a schematic view of an example of a module comprising independent axial and radial adjustments with a motor with two output shafts, only one of which is in rotation at a time,

FIG. 4 is a schematic view of another example of a module comprising independent axial and radial adjustments with a mobile motor, a fixed clutch and a permanent screw,

FIG. 5 is a schematic view of an example of a module comprising interdependent axial and radial adjustments with one motor, one clutch and one permanent screw, and

FIG. 6 is a schematic view of another example of a module comprising interdependent axial and radial adjustments with one motor with two output shafts (only one shaft 1 rotates for radial adjustment or both rotate at the same speed for axial adjustment).

### DETAILED DESCRIPTION

It will be appreciated that the following description is intended to refer to specific embodiments of the invention selected for illustration in the drawings and is not intended to define or limit the invention, other than in the appended claims.

This invention pertains in its most general sense to a steering column motorized positioning control module comprising a single motor that adjusts the position of the steering wheel along a transverse pivoting axis and the tilt of the steering wheel, on the one hand, and along a longitudinal axis for adjustment of the length on the other hand. The motor drives displacement of a first threaded joint providing a first adjustment mechanism along one of the axes and a second threaded joint drives a second adjustment mechanism along at least the other of the axes. The module comprises a controller for storage in memory of at least one reference position along the two axes and for comparing between a reference position and an effective position along the two axes. The single motor drives a single incremental position sensor sending a position signal to the controller and the controller receives representative information on the state of at least one of the joint elements.

This single incremental sensor can be either directly on the motor or on any element of the transmission or even on the output shaft.

This state can be engaged or disengaged when the joint has a clutch, or is active or inactive in the case of a motor with two output shafts one or the other of which is driven. The information relative to the state of the joint elements comes from the control circuit which controls the operation of the adjustment mechanism.

An advantage of this system is to have a single relative sensor for all of the positioning function of the column along the two axes. This sensor can moreover easily be integrated in the motor or on an element of the transmission which actuates the adjustment, thereby decreasing the number of components on the column and thus also simplifying the wiring.

An electrically controlled steering column makes it possible to adjust the position of the steering wheel along two axes:
axial adjustment for moving the steering wheel closer to or further away from the driver,
radial adjustment for adjusting the position of the steering wheel from top to bottom, or notably for vehicles intended for the American market, to adjust the tilt of the steering wheel from a more or less horizontal position to a rather vertical position.

According to one aspect, one of the joint elements drives axial displacement in translation of the steering column in relation to the fixed part of the module and the other joint element drives rotation of the steering column in relation to a transverse pivoting axis of the steering column in relation to the fixed part of the module, each of the joint elements cooperating with a single threaded screw driven by the single motor. The first module comprises a controller that engages at least one of the joint elements with the threaded screw, the controller sending the activating information corresponding to the state of the clutches.

According to another aspect, one of the joint elements is in permanent hold with the screw driven by the single motor. The controller has a first memory register incremented as a function of the variations of the incremental sensor only when the clutch of the first joint means is activated and a second memory register incremented as a function of variations of the permanent incremental sensor.

According to a mode of implementation adapted for principally controlling the tilt of the steering wheel, the pivot is located at the side of the steering column and the closest fixed part of the steering wheel. According to a mode of implementation adapted for controlling principally the height of the steering column, the pivot is located at the side of the steering column and the most distant fixed part of the steering wheel.

Irrespective of which aspect is envisaged, the module advantageously comprises detectors of the position of the joint elements in relation to a reference position, sending a reinitialization signal from the memory registers. These detectors can be, e.g., microswitches, an optical, magnetic, inductive or capacitive detector or the like.

According to yet another aspect, each of the joint elements is coupled by the intermediary of a clutch with the screw driven by the single motor. The controller comprises a first memory register incremented as a function of variations of the incremental sensor when the clutch of the first joint means is activated, and a second memory register incremented as a function of variations of the incremental sensor when the clutch of the second joint means is activated.

According to still another aspect, the module comprises detectors of the position of the joint elements in relation to a reference position, the sensors sending a reinitialization signal from one of said memory registers.

According to one particular mode of implementation, the single motor comprises two output shafts and a switch that selects one or the other of the shafts or both shafts substantially simultaneously.

One of the joint elements cooperates via a screw-nut link with one of the output shafts to drive axial displacement in translation of the steering column in relation to the fixed part of the module. Another of the joint elements cooperates via a screw-nut link with the other output shaft to drive rotation of the steering column in relation to a transverse pivoting shaft of the steering column in relation to the fixed part of the module, the module comprising a switch sending the activation information corresponding to the state of the output shafts.

The invention also pertains to a controller for a module comprising a first register incremented by the pulses sent by the incremental sensor driven by the single motor when an axial adjustment is selected and a second register incremented by the pulses sent by the incremental sensor driven by the single motor when a tilt adjustment is selected.

The first register is advantageously reinitiated by a signal sent by a first detector when the axial joint element is in a reference position and a second register is reinitialized by a signal sent by a second detector when the radial joint element is in a reference position.

According to one variant, the controller comprises a first register incremented by the pulses sent by the incremental sensor driven by the single motor when an adjustment according to one of the adjustment modes is selected and a second register incremented by the pulses sent by the incremental sensor driven by the single motor.

The registers are advantageously reinitialized by two signals sent by the detectors when the two joint elements are each in reference position. These detectors can be, e.g., microswitches, an optical, magnetic, inductive or capacitive detector or the like.

The invention can be implemented by different forms of implementation having as their common characteristic motorization by a single motor with a single incremental sensor on the motor or a transmission element. The control of the position adjustment of a single-motor column uses a single relative cyclical sensor, e.g., a Hall effect wave sensor or an optical or magnetic sensor that sends rotation information from the motor that drives the output screw(s) on which are displaced the joints that provide for axial or angular adjustment.

According to the transmission connected to the motor and the relative positioning of the sensor in the system, the number of cycles given by this sensor by motor rotation is variable from one column to another, and the transmission ratio is taken into account in the description below.

The controller comprises a counting system (C) that counts the pulses sent by this sensor. The pulses are counted in one direction of rotation of the motor, and deducted in the other direction of rotation. According to the adjustment shaft selected, these pulses are to be taken into account either for measuring the axial displacement or for measuring the radial displacement.

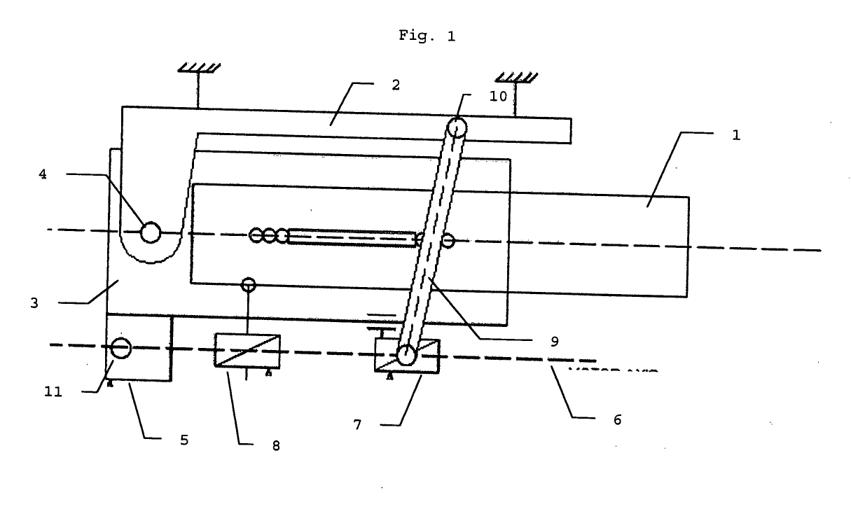

FIG. 1 shows a schematic view of an example of a module comprising independent axial and radial adjustments with one motor and two clutches. The module described in reference to FIG. 1 comprises a steering column (1) mobile along two axes in relation to a fixed part (2) intended to provide the connection between the module and the passenger compartment of the motor vehicle.

The steering column (1) is mobile in translation in relation to a sleeve (3) integral with the fixed part (2). Sleeve (3) is mobile in rotation around a transverse axis (4) perpendicular to the vertical plane passing through the axis of the steering column (1). Axis (4) is located at the side opposite to the end of the column on which the steering wheel is mounted. Tilting of sleeve (3) in relation to axis (4) provides adjustment by height of the steering wheel and a slight modification of the tilt of the steering wheel.

The module comprises a single motor (5) driving an endless screw (6) parallel to the longitudinal axis of the steering wheel (1). Two joint elements (7, 8) are mounted on endless screw (6). The first joint element (7) provides for tilting movement of sleeve (3) in relation to fixed part (2). It comprises for this purpose a connecting rod (9) one end of which is articulated on joint element (7) and the other end of which is articulated in relation to a connecting shaft with fixed part (2).

Displacement of first joint element (7) along endless screw (6) modifies the angle formed by connecting rod (9) with the longitudinal axis and thus the transverse offsetting of connecting point (10) with the axis of steering column (1) and therefore the angle that the axis of steering column (1) forms with fixed part (2) as well as the height position of the steering wheel.

Displacement of first joint element (7) provides for angular displacement of steering column (1) and height adjustment of the steering wheel. It is not driven permanently by screw (6), but cooperates with the screw (6) by the intermediary of a clutch. When joint element (7) is in the engaged state, it provides for the angular adjustment of steering column (1): whenever the motor rotates in one direction or the other, joint element (7) is displaced in translation in one direction or the other, and the angular position of steering column (1) is modified in relation to fixed part (2). When joint element (7) is in the disengaged state, this joint element cannot be displaced even if screw (6) is moving in rotation.

Displacement of second joint element (8) provides for axial displacement of steering column (1) and adjustment of the distance of the steering wheel. It is not driven permanently by screw (6), but cooperates with screw (6) by the intermediary of a clutch. When joint element (8) is in the engaged state, it provides for axial adjustment of steering column (1): whenever the motor rotates in one direction or the other, joint element (8) is displaced in translation in one direction or the other, and the axial position of steering column (1) is modified. When joint element (8) is in the disengaged state, it is not displaced even if screw (6) is moving in rotation.

Motor (5) is coupled directly or indirectly to a relative Hall effect wave sensor sending one pulse at each rotation turn.

In the example of implementation described in FIG. 1, the controller comprises two counters. A first counter receives pulses originating from the relative sensor and is incremented or decremented as a function of the signal of the rotation direction each time that the motor drives screw (6) and second joint element (8) is engaged. The state of this first counter corresponds to the axial position of the steering column.

The second counter also receives pulses originating from the relative sensor and is incremented or decremented as a function of the signal of the rotation direction each time that the motor drives screw (6) and that first joint element (7) is in the engaged state. The state of the second counter corresponds to the angular position of the steering column.

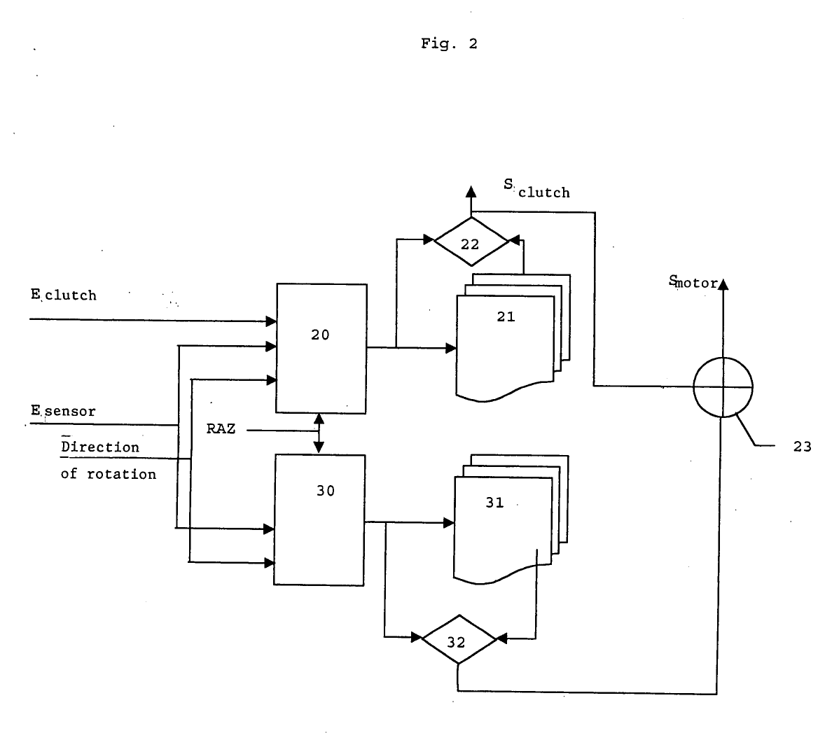

FIG. 2 shows a schematic view of a controller. It comprises a first counter (20) of axial position receiving:
on a first input a signal corresponding to the engagement state of second joint element (8). The information originates from the logical command circuit,
on a second input the pulses originating from the relative sensor,
on a third input a signal corresponding to the direction of rotation of the motor. This information originates from the logical command circuit.
on a fourth input a reinitialization signal.

Counter (20) is incremented by each pulse received on the second input when the first input receives a signal corresponding to the engaged state and when the third input receives a signal corresponding to a first direction of rotation. Counter (20) is decremented by each pulse received on the second input when the first input receives a signal corresponding to the engaged state and when the third input receives a signal corresponding to an inverse direction of rotation. Counter (20) is maintained in its prior state in the other cases.

The controller comprises a second counter (30) of radial position which receives:
on a first input a signal corresponding to the engagement state of first joint element (7). This information originates from the logical command circuit.
on a second input the pulses originating from the relative sensor,
on a third input a signal corresponding to the direction of rotation of the motor,
on a fourth input a reinitialization signal.

Counter (30) is incremented by each pulse received on the second input when the first input receives a signal corresponding to the engaged state and when the third input receives a signal corresponding to a first direction of rotation. Counter (30) is decremented by each pulse received on the second input when the first input receives a signal corresponding to the engaged state and when the third input receives a signal corresponding to an inverse direction of rotation. Counter (30) is maintained in its prior state in the other cases.

The circuit moreover comprises for each of the two counters, an input receiving the information corresponding to the motor output shaft selected (instead of the inputs of each of the inputs receiving a signal corresponding to the engagement state).

Lastly, when the two joint elements come into a reference position in which are placed the position detectors, a return to zero signal reinitializes counters (20, 30). The two returns to zero are not simultaneous.

Each of counters (20, 30) is linked to a memory register (21, 31) for recording the position couples by a driver. These position couples enable the driver who recorded them to return to a favorite position. Restoration of a prerecorded position is effected by two comparators (22, 32), the first commands the engagement of second joint element (9) when the axial position measured by first counter (20) corresponds to the prerecorded position in first register (21) and the second comparator commanding the engagement of first joint element (7) when the radial position measured by second counter (30) corresponds to the prerecorded position in second register (31). Processing of the information by the calculator can give rise to diverse variants.

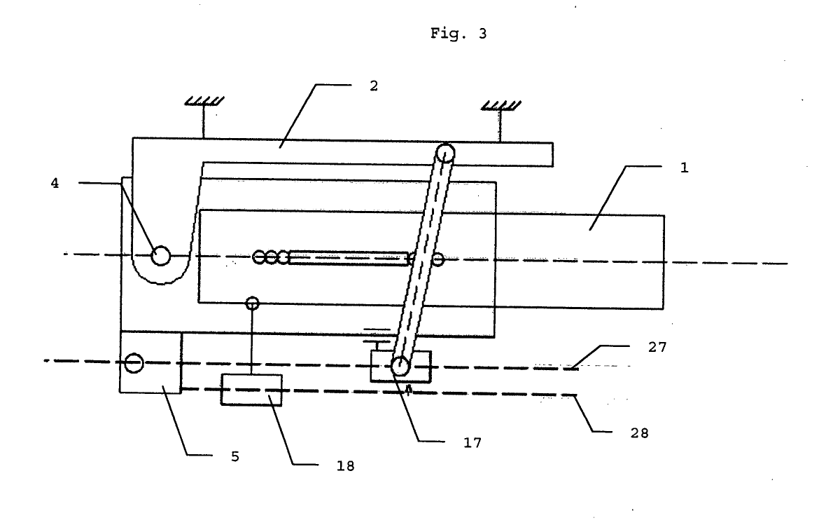

FIG. 3 shows a schematic view of an example of a module comprising independent axial and radial adjustments with a motor with two output shafts only one of which is in rotation at a time.

This is a variant of implementation of the preceding solution. Motor (5) drives two screws (27, 28) via the intermediary of a switch mechanism providing the driving of screw (27) or (exclusive) of screw (28). Motor (5) is connected directly or indirectly to a single relative sensor sending a transmitted signal to the controller. The radial position counter is incremented or decremented depending on the direction of rotation of motor (5) when screw (27) driving joint element (17) is active.

When screw (28) driving the joint element (18) is active, it is the axial position counter which is incremented or decremented depending on the direction of rotation of motor (5). Moreover, the reference position detectors send a signal for reinitialization of the counters.

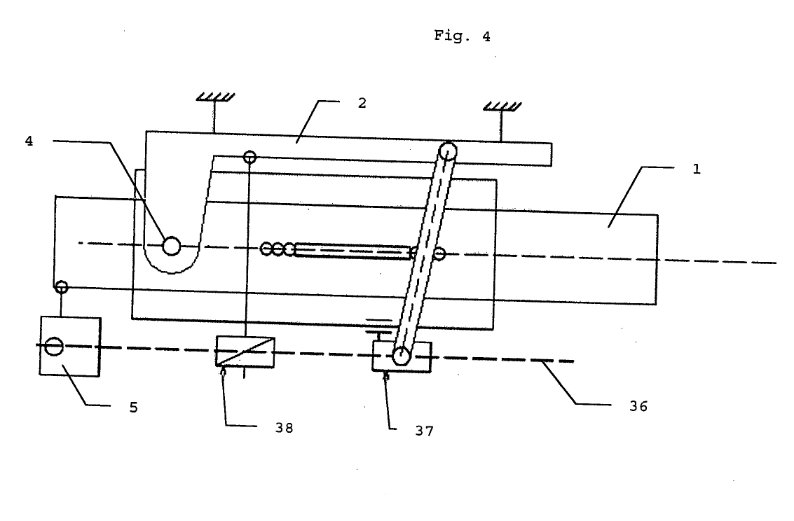

FIG. 4 shows a schematic view of another example of a module comprising independent axial and radial adjustments with a mobile motor, a fixed clutch and a permanent nut. Single motor (5) is not fixed in relation to the passenger compartment, but integral with mobile column (1) with which it is displaced.

Motor (5) drives a screw (36) parallel to the steering column (1) driving via a permanent screw-nut link a first joint element (37) actuating a connecting rod the opposite end of which is linked to fixed part (2) by a transverse articulation. It provides tilting adjustment of the steering wheel.

Screw (36) also drives via a screw-nut link that can be disengaged a second joint element (38) linked to fixed part (2). It provides for the depth adjustment of the steering wheel. In the same manner, a single relative sensor is coupled directly or indirectly to the motor and sends pulses to two counters one of which is incremented and decremented with each rotation of the motor, and the other when second joint element (38) is engaged.

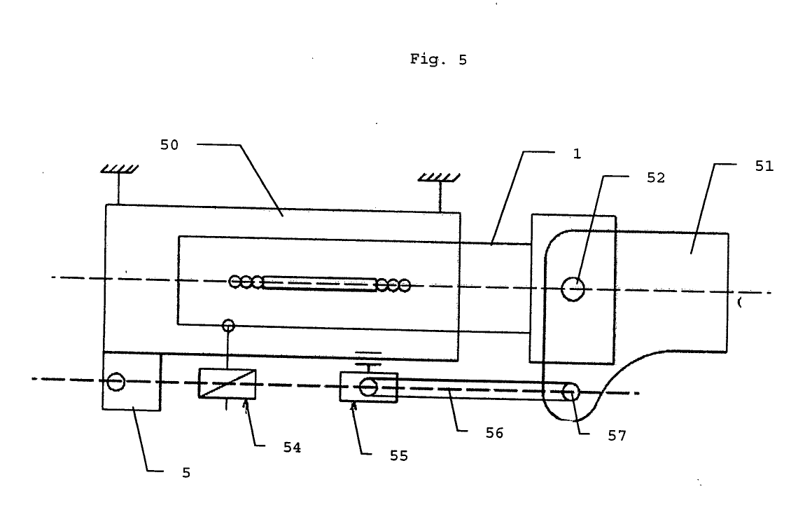

FIG. 5 shows a schematic view of a module comprising interdependent axial and radial adjustments with a motor, a clutch and a permanent nut. Steering column (1) has at its end closest to the steering wheel a pivot (52) enabling tilting of a plate (51) which comprises the top part of the axis of the steering wheel on which the steering wheel will be mounted. Steering column (1) can slide axially in relation to a sleeve (50). A single electric motor (5) drives a screw with which cooperates a first joint element (54) which can be disengaged and axially displaces steering column (1) in relation to fixed sleeve (50), and a second joint element (55) permanently held by a screw-nut link. Second joint element (55) actuates a connecting rod (56) cooperating with plate (51) via the intermediary of an articulation.

As with the preceding solutions, a single relative sensor is coupled directly or indirectly with the motor to send pulses to a first axial position counter incremented or decremented solely when joint element (54) is engaged and a second position counter permanently incremented or decremented.

The first counter receives pulses originating from the relative sensor and is incremented or decremented as a function of the direction of rotation signal each time that the motor drives screw (56) and that first joint element (54) is in the engaged state. The state of the first counter corresponds to the axial position of the steering column.

The second counter also receives pulses originating from the relative sensor and is incremented or decremented as a function of the direction of rotation signal each time that the motor drives screw (56). The angular position of the column corresponds to the state of this second counter from which is subtracted the first counter.

As in the other examples, the reinitialization of the counters is performed by reference position detectors.

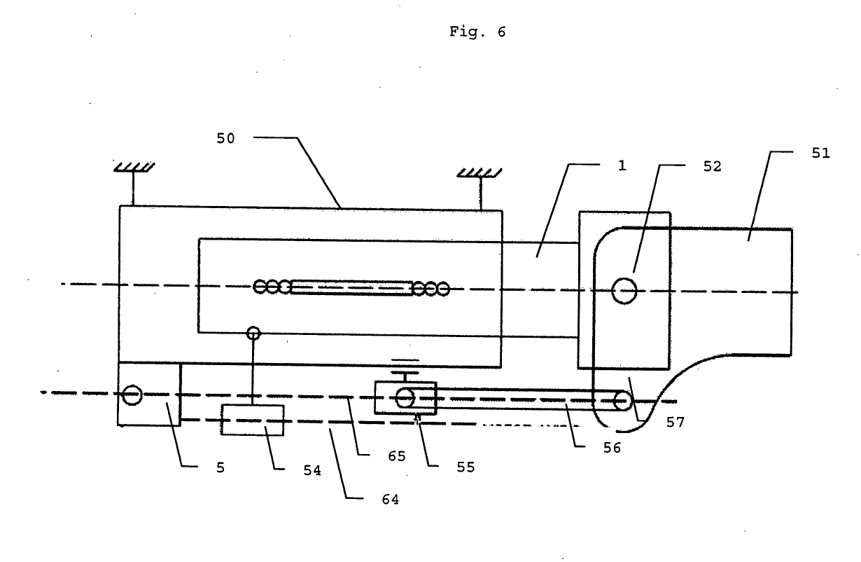

FIG. 6 shows a schematic view of another example of a module comprising interdependent axial and radial adjustments with one motor with two output shafts (only shaft (65) rotates for radial adjustment while both shafts rotate at the same speed for axial adjustment). This version corresponds to an implementation employing a single motor (5) driving two output shafts (64, 65). First shaft (64) drives joint element (54) providing for axial displacement of steering column (1). Second shaft (65) drives joint element (55) providing for orientation of plate (51).

The controller associated with its different mechanisms having all of the characteristics comprises:
a single motor providing both adjustment in depth and in depth and/or in orientation,
a single relative sensor coupled directly or indirectly to a single motor,
a disengagement means for at least one of the joint elements or a switch of the output shaft of the motor,
two counters counting the number of pulses sent by the position sensor as a function of the additional information on the direction of rotation and the state of the disengagement mean(s) or the state of the active output shaft(s), and
one or more position detectors of the joint elements sending a reinitialization signal from the counters.

The counters can send either an image respectively of the axial position and the radial position or respectively an image of one of these two positions and an image of the combination of the two positions. In the latter case, the information corresponding to the other position is determined by subtraction between the content of the two counters.

The different counting modes can be presented in the following manner. In the case of two output screws, one being the “radial” screw for driving the joint that provides the tilt adjustment and the other being the “axial” screw that drives the joint that provides the adjustment in translational movement:

In one case, the “Axial” counter counts all of the pulses when the “axial” screw is active. The second counter is then a “combined” counter counting all of the pulses no matter which screw is engaged. The “radial” position information is calculated by the difference between the two counters.

In another case, the “Axial” counter counts all of the pulses when the “axial” screw is active. The second counter is a “radial” counter counting all of the pulses when the “axial” screw is not engaged.

In the case of a single output screw:

In one case, the “Axial” counter counts all of the pulses when the “axial” joint element is engaged. The second counter is a “combined” counter counting all of the pulses irrespective of the engagement state. The “radial” position information is calculated by the difference between the two counters.

In another case, the “Axial” counter counts all of the pulses when the “axial” joint element is engaged. The second counter is a “radial” counter counting all of the pulses when the “axial” joint element is not engaged.

In another case, the “Axial” counter counts all of the pulses when the “axial” joint element is engaged. The second counter is a “radial” counter counting all of the pulses when the “radial” joint element is engaged.

1. A steering column module for commanding motorized positioning comprising:
a motor that adjusts the position of a steering wheel associated with the steering column relative to a driver along a transverse pivoting axis for adjustment of the tilt of the steering wheel with respect to the driver and along a longitudinal axis for adjustment of the distance of the steering wheel relative to the driver;
a first threaded joint element driven by the motor and providing a first adjustment mechanism along one of the axes;
a second threaded joint element driven by the motor and driving a second adjustment mechanism along at least another of the axes;
a controller that receives information representative on the state of at least one of the joint elements; and
an incremental position sensor driven by the motor that sends a position signal to the controller.

2. The steering column module according to claim 1, wherein one of the joint elements drives axial displacement in translation of the steering column in relation to a fixed part of the module, and the other joint element drives rotation of the steering column in relation to an axis of transverse pivoting of the steering column in relation to the fixed part of the module, each of the joint elements cooperating with a single threaded screw by the motor, and the module further comprising command means for engaging at least one of the joint elements with the threaded screw, the command means sending the information.

3. The steering column module according to claim 1, wherein the incremental sensor comprises a Hall effect wave sensor or a magnetic or optical or inductive/capacitive sensor integral with a shaft of the motor, a transmission element of the motor or an output shaft of the motor.

4. The steering column module according to claim 2, further comprising at least one position detector for reinitialization of counters in the controller.

5. The steering column module according to claim 2, wherein one of the joint elements is permanently held with the screw and the controller comprises a first memory counter incremented as a function of variations of an incremental sensor solely when a clutch of the first joint element is activated and a second memory counter is incremented as a function of variations of the incremental sensor.

6. The steering column module according to claim 5, further comprising detectors of positions of the joint elements in relation to a reference position sending a reinitialization signal of the memory counters.

7. The steering column module according to claim 2, wherein each of the joint elements is coupled by a clutch with the screw and the controller comprises a first memory counter incremented as a function of variations of an incremental sensor when a clutch of the first joint element is activated and a second memory counter incremented as a function of variations of the incremental sensor when a clutch of the second joint element is activated.

8. The steering column module according to claim 2, further comprising detectors of positions of the joint elements in relation to a reference position, each of the detectors sending a reinitialization signal from a memory counter.

9. The steering column module according to claim 1, wherein the motor comprises two output shafts and a switch selecting one or another of shafts or both, one of the joint elements cooperating via a screw-nut link with one of the output shafts to drive axial displacement in translation of the steering column in relation to a fixed part of the module, and another of the joint elements cooperating via a screw-nut link with the other output shaft to drive rotation of the steering column in relation to the transverse pivoting axis in relation to a fixed part of the module, the switch sending the information corresponding to the switch.

10. A controller for a module according to claim 1, comprising a first counter incremented by pulses sent by an incremental sensor driven by the motor when an axial adjustment is selected and a second counter incremented by pulses sent by the incremental sensor when a tilt adjustment is selected.

11. The controller according to claim 10, wherein the first counter is reinitialized by a signal sent by a first detector when an axial joint is in a reference position and a second counter is reinitialized by a signal sent by a second detector when a radial joint element is in a reference position.

12. The controller according to claim 10, further comprising a first counter incremented by pulses sent by the incremental sensor when an adjustment according to an adjustment modes is selected and a second counter incremented by pulses sent by the incremental sensor.

13. The controller according to claim 10, wherein the counters are reinitialized by a signal sent by a detector when the joint elements are in a reference position.
